(19) United States
(12) Patent Application Publication
(10) Pub. No.: US 2010/0162560 A1
(43) Pub. Date: Jul. 1, 2010

(54) METHOD AND SYSTEM FOR REMOVING WEDGES

(76) Inventors: Brock M. Lape, Clifton Park, NY (US); Gary L. Stewart, Pittsburgh, PA (US); Michael J. Bousquet, Hewitt, NJ (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(21) Appl. No.: 12/347,319

(22) Filed: Dec. 31, 2008

(51) Int. Cl. H02K 15/00; H02K 3/487

(52) U.S. Cl. 29/764; 310/214

(57) ABSTRACT

A method and system for removing a wedge within a slot of an armature or field of a dynamoelectric machine is provided. The armature or field includes a core. A saw includes a blade for cutting the wedge. At least one guide is used for guiding the saw along the slot during use. Using the saw to cut the wedge facilitates wedge removal. The wedge can be removed after the saw has cut it.

### BACKGROUND OF THE INVENTION

This invention relates to dynamoelectric machines and, in particular, to a method and system for removing stator slides and/or stator wedges in the stator core of a generator or motor.

Dynamoelectric machines, such as generators or motors, typically employ a stator or armature core comprised of stacked laminations of magnetic material forming a generally annular assembly. An array of axially extending circumferentially spaced stator core slots are formed through the radial inner surface of the annular assembly. Armature or stator windings are disposed in these slots. A rotor or field is coaxially arranged within the stator core and contains field windings typically excited from an external source to produce a magnetic field rotating at the same speed as the rotor. With the foregoing arrangement, it will be appreciated that electrical output is generated from the armature windings.

Stator or armature windings are seated within the stator core slots and are held in place by a slot support system that includes stator wedges, stator slides, filler strips and ripple springs. These support components are employed in order to maintain the stator armature windings in a radially tight condition within the slots. The armature windings of generators operate under continuous strain of electromagnetic forces that must be completely contained to prevent high voltage armature winding insulation damage. Relative movement between the armature windings and stator core can also exacerbate insulation damage. The wedges, slides, filler strips and ripple springs impose radial forces on the armature windings and aid the windings in resisting magnetic and electrically induced radial forces.

The stator wedges are received within axial dovetail slots on opposite sidewalls of the radial slots. During the process of tightening the stator wedges, it is necessary to install a stator slide against each stator wedge. For the sake of convenience, reference will be made herein to “stator wedges” that are seated in the dovetail slots and “stator slides” that are used to tighten the wedges. The stator slide can be, but is not necessarily, pre-gauged and pre-sized to have a significant interference fit relative to the slot contents, i.e., the windings, fillers and ripple springs. The force required to install the stator slide may be thousands of pounds.

Several methods have been used to provide the force required to remove the stator wedges. For example, stator wedges have been manually removed using a drive board and a large hammer, or by using a modified pneumatically operated hammer. These methods, however, are time consuming and place considerable strain on the operator. They also subject the operator to fatigue, the risk of repetitive motion injury and/or hearing damage, and pose a risk to the integrity of the stator core and armature windings. The hammering technique can also cause stator damage, which results from off-center hits, or an operator can inadvertently miss the wedge and hit the stator core, resulting in damage to the core and a lengthy and time-consuming process to fix the damaged core portions.

### BRIEF SUMMARY OF THE INVENTION

According to one aspect of the present invention, a system for removing a wedge within a slot of an armature or field of a dynamoelectric machine is provided. The armature or field includes a core. The system includes a saw having a blade for cutting the wedge. At least one guide is provided for guiding the saw along the slot. Wedge removal is facilitated by using the saw to cut the wedge.

According to another aspect of the present invention, a method is provided for removing a wedge from within a slot of an armature or field of a dynamoelectric machine. The armature or field includes a core. The method includes providing a saw having a blade for cutting the wedge. Another step includes providing at least one guide for guiding the saw along the slot. A cutting step cuts the wedge with the saw, and is followed by removing the wedge from the slot.

### BRIEF DESCRIPTION OF THE DRAWINGS

FIG. 1 is a partial, axial cross-sectional illustration of a stator core slot with a stator slide and a stator wedge in place.

FIG. 2 is a partial, perspective illustration of a stator core. FIG. 3 is an enlarged, partial perspective illustration of a stator core, and shows the interrelation between the stator slots and the stator wedges.

FIG. 4 is a perspective illustration of a saw used to remove the stator wedges, according to one embodiment of the system of the present invention.

FIG. 5 is a perspective illustration of the guide rails in place on the stator core, according to one embodiment of the system of the present invention.

FIG. 6 is a perspective illustration of one embodiment of a system used to remove the stator wedges, according to one embodiment of the system of the present invention.

### DETAILED DESCRIPTION OF THE INVENTION

Dynamoelectric machines, such as generators and motors, can have very long operational lifetimes with periodic maintenance and upgrades. Many generators have been in service for decades, and can benefit from newer technologies and materials. While nearly all of generator components may be upgraded during the service life, stator rewind and field rewind are by far the most convenient and powerful means of achieving both a higher efficiency and a higher output. Rewinds always present an opportunity for the original equipment manufacturer to enhance the performance of the machine and support a turbine uprate. The economics of such design upgrades can often help to justify the cost of the rewind activity.

Advances in the area of non-metallic materials, insulation systems and composites allow significant reliability improvements and life extension to be achieved by replacing old materials that are approaching the end of their useful lives. An example of this type of enhancement is the replacement of an asphalt-insulated stator winding with a modern epoxy-based insulation system. Since the insulation is life-limited, by replacing the stator winding with anew one, often of a higher thermal class insulation system, it is possible to reset the “time clock” on the stator winding. Beyond simple replacement of materials, significant reliability enhancement can be obtained through upgrading the design of the winding insulation and the winding support system. New wedging systems may also be installed that can include pressure wedges made of non-shrinkable and non-abrasive material, as well as improved ripple springs and slides. However, before any upgrades can be performed the old materials must be removed first. The various aspects of the present invention provide an improved method and system to remove the stator bar wedging system (e.g., wedges, ripple springs, slides, etc.). It is to be understood that the method and system can also be applied to the rotor as well.

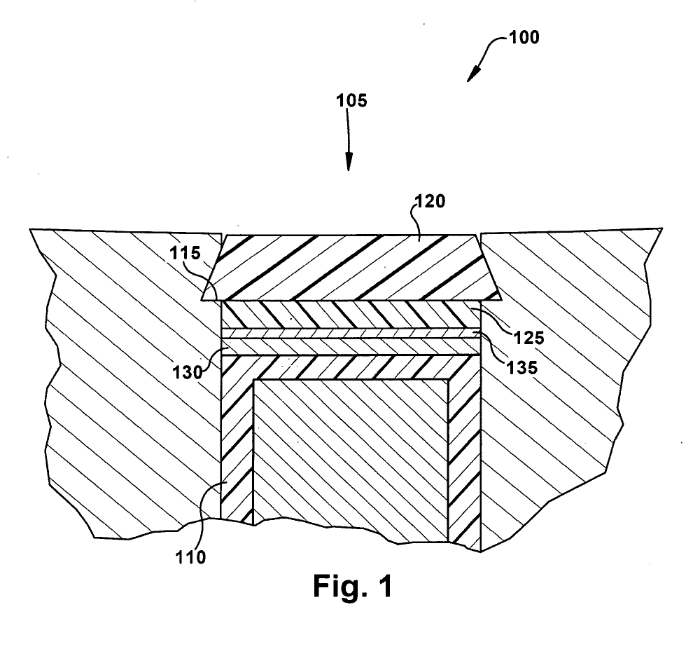

Referring to FIG. 1, a magnetic stator core for a generator is partially shown at 100. The drawing is not necessarily to scale and the individual elements are shown to illustrate the interaction between the various elements. The description hereinafter describes a method and system used with generators, but it is to be understood that the method and system of the present invention can be used with motors and any other suitable dynamoelectric machines. The stator core can be formed of many laminations of a magnetic steel or iron material. Typically, laminations are arranged in groups, and each group is separated by a spacer (not shown in FIG. 1). The spacers define axially spaced gaps between groups of laminations, and these gaps permit ventilation and cooling of the stator core 100. A plurality of radially oriented stator slots 105 extend axially along the stator core, with armature windings 110 seated therein. Typically, one or two armature windings 110 are present in each slot 105, but three or more could also be present. Each slot 105 is formed adjacent its mouth with a dovetail groove or undercut 115 in opposed side walls of the slot 105, permitting several to many stator wedge 120 and stator slide 125 components to be inserted in an axial direction along the length of the slot 105. It will be understood that flat filler strips 130 and ripple springs 135 may be disposed between the windings 110 and the stator wedges 120 and stator slides 125 as shown in FIG. 1. In some applications, various ripple springs and/or filler strips may also be disposed between the winding 110 and sidewalls and/or bottom of the slot 105. In some applications, the individual stator wedges 120 and slides 125 are generally between about 3 and 12 inches in length, and the stator core may have a length of between about 50 and 350 inches, and a diameter of between about 3 to 12 feet. Accordingly, up to 3,000 or more stator wedges 120 may need to be removed in a typical generator rewind.

The stator wedges 120 and stator slides 125, as well as the filler strips 130, can be constructed of a woven glass fabric combined with a high temperature resin. This material has excellent mechanical strength and electrical properties at elevated temperatures. The ripple springs 135 can be constricted of a unidirectional glass fabric combined with epoxy resin. The ripple springs have a wavy or sinusoidal shape along their length. This waviness gives the ripple springs resiliency, and this resiliency helps to absorb the expansion and contraction of the armature windings 110 during the various operating cycles of a generator, while maintaining the armature windings 110 tightly constrained within the stator slot 105. Alternatively, any other suitable material can be used for the stator wedges, stator slides, filler strips and ripple springs. In other embodiments, the material may also include magnetic particles, to enhance the magnetic characteristics of the stator core.

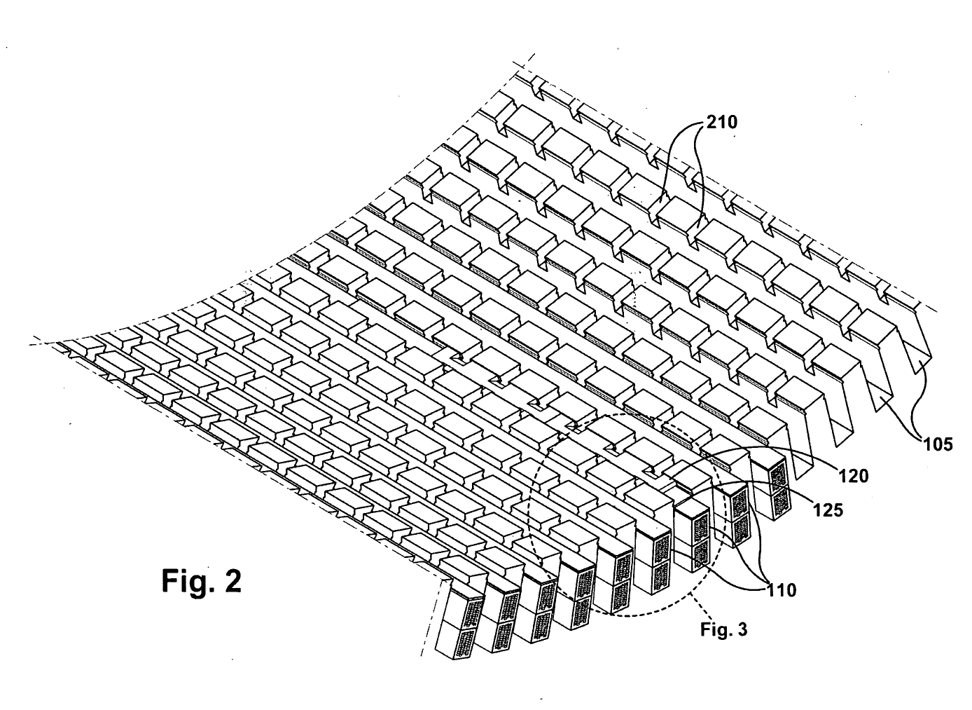

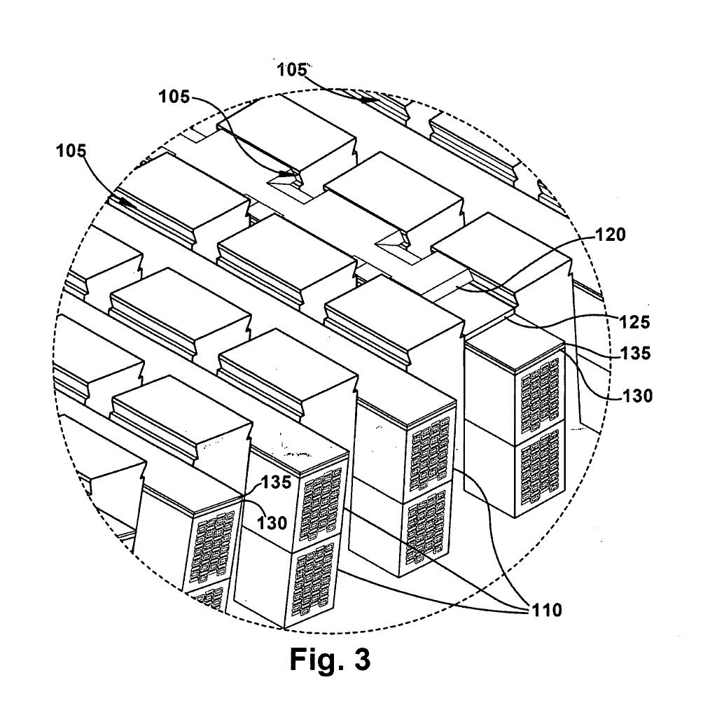

With reference to FIGS. 2 and 3, the stator core 100 has a plurality of stator slots 105, generally extending in an axial direction, which contain the armature windings 110. As one example, two armature windings 110 may be contained within each stator slot 105. The stator core is comprised of many laminations of magnetic steel or iron material. The laminations form groups, and these groups are separated by spacers. The spacers define vent gaps 210, which are generally orthogonal to the stator slots 105. The vent gaps 210 between the groups of laminations allow for ventilation and cooling of the stator core. The armature windings 110 are housed in the lower portion of the stator slots 105. Various filler strips 130 and ripple springs 135 may be located above, below and to the sides of the armature windings. A dovetail wedge 120 is located in dovetail groove 115 and a slide 125 is located under the wedge 120.

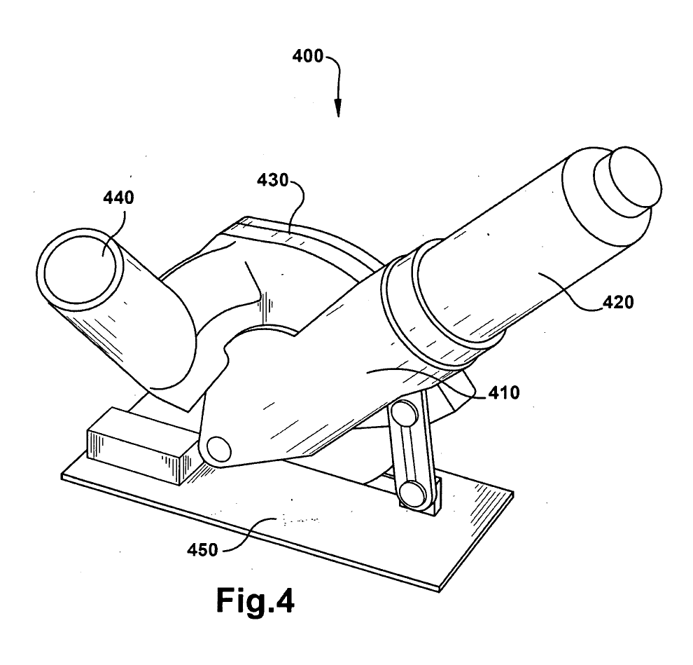

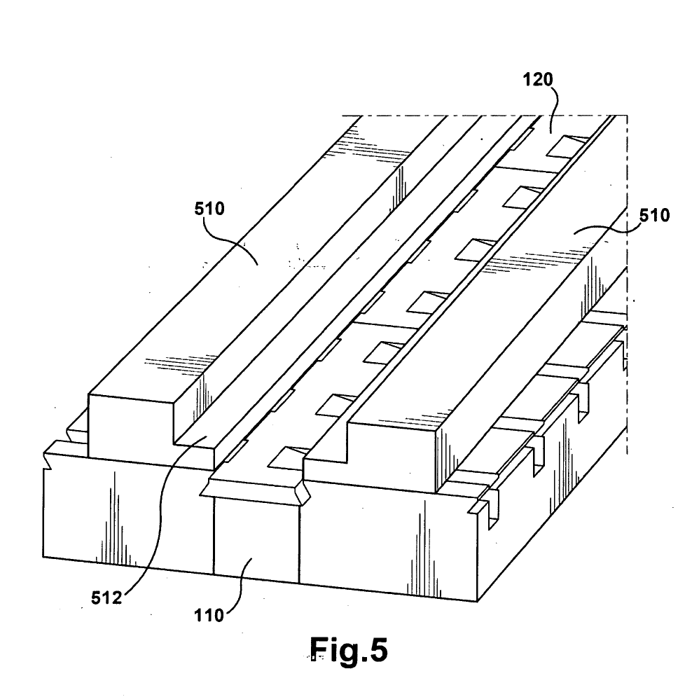

A system and method for removing a stator wedge 120 will now be described with reference to FIGS. 4 to 6. A wedge saw 400 is used to cut out stator wedges 120 in dynamoelectric machines, such as generators. The saw 400 is comprised of a motor 410, handle 420, blade guard or dust guard 430 covering a circular blade (not shown), vacuum exhaust port 440 and base plate 450. The base plate 450 also contains and adjustable depth of cut mechanism so that a desired depth of cut can be preset and locked on saw 400. The saw is preferably configured as a hand-held tool and may be powered by compressed air, batteries, AC or DC electrical power. A compressed air powered motor 410 has the advantage of being able to be stalled without damage, as well as being able to be used in humid or wet locations.

The saw 400 can use diamond grit discs or blades preferably chosen to cut the material of the stator wedges 120. Typically, stator wedges are made from a fiberglass-like material and the blade of saw 400 may be a circular disc or blade that is diamond coated. Alternatively, the blade or disk can be diamond coated porcelain, diamond impregnated, diamond grit of made from any suitable steel alloy.

At least one guide rail 510 can be secured to the stator core. The guide rails 510 can be mechanically and/or magnetically attached to the stator core. The saw base plate 450 rides along the guide rail(s) during a cutting operation. The guide rails 510 help to ensure the integrity of the stator core as well as allow the operators the ability to concentrate on the cut. The thickness of the lower portion 512 of guide rail 510 can be chosen to prevent cuts that may reach the windings 110. The saw base plate 450 has an adjustable depth of cut and has a maximum cutting depth (e.g., two inches). The thickness of lower portion 512 can be sized so that even at maximum cutting depth, the saw will only cut into wedge 120 and not the adjacent slides, filler strips or ripple springs. In alternative embodiments, the dimension of lower portion 512 can be designed so that only a portion of wedge 120 remains uncut or that only a portion of slide 125 can be cut. In use, the saw's baseplate 450 can be slid along lower portion 512 while being guided by the thicker portion of guide rail 510.

In some embodiments of the present invention one guide rail 610 may be used during a cutting operation. In this application a spacer block (not shown) may be affixed to the bottom of baseplate 450 on the side opposite the guide rail. This will keep the saw 400 level during the cutting operation. The spacer block should be sized at about the same thickness as lower portion 512. The guide rails and spacer block can be made from any suitable polymeric material, or any other material that will assist in protecting the stator core from damage. If desired, an auxiliary guide clamp 620 can be used to help guide the saw 400 along guide bar 610.

The saw can be equipped with a vacuum exhaust port 440 so that air pollution or the amount of cutting debris is reduced. Any suitable vacuum source can be connected to vacuum port 440 and may be activated when the saw is turned on. The dust guard 430 and vacuum port 440 work together to reduce the escape of cutting debris.

A method for removing a stator wedge will now be described, according to aspects of the present invention. A saw is provided having a blade or disc suitable for cutting the stator wedges. Typically, this is a fiberglass-type material. At least one guide rail 510 is secured to the stator core. The guide rail(s) can be secured mechanically and/or magnetically to the stator core. In one embodiment, one or more magnets are disposed on the bottom of guide rail 510.

After the guide rail(s) 510 are correctly positioned, the saw 400 can be aligned with the guide rails. In applications with two guide rails, the saw rides along lower portions 512. In applications using only one guide rail one side of baseplate 450 rides along lower portion 512 while the other side of baseplate 450 is supported by an optional spacer block.

The blade of the saw may be preset at the desired depth of cut, or may be “plunged” into the wedge to start the cutting operation. Both operations are followed by moving the saw along the slot 105 to cut one or more wedges 120. After the wedges are cut they will most likely pop up so that they can be removed. However, in some cases the wedges may need to be extracted after cutting.

According to some aspects of the present invention, the saw 400 can be designed to have a reduced profile, reduced weight and reduced height. A tool with reduced weight will help to reduce operator fatigue. In tight workspaces or workspaces with limited accessibility, a smaller tool is easier to position and operate.

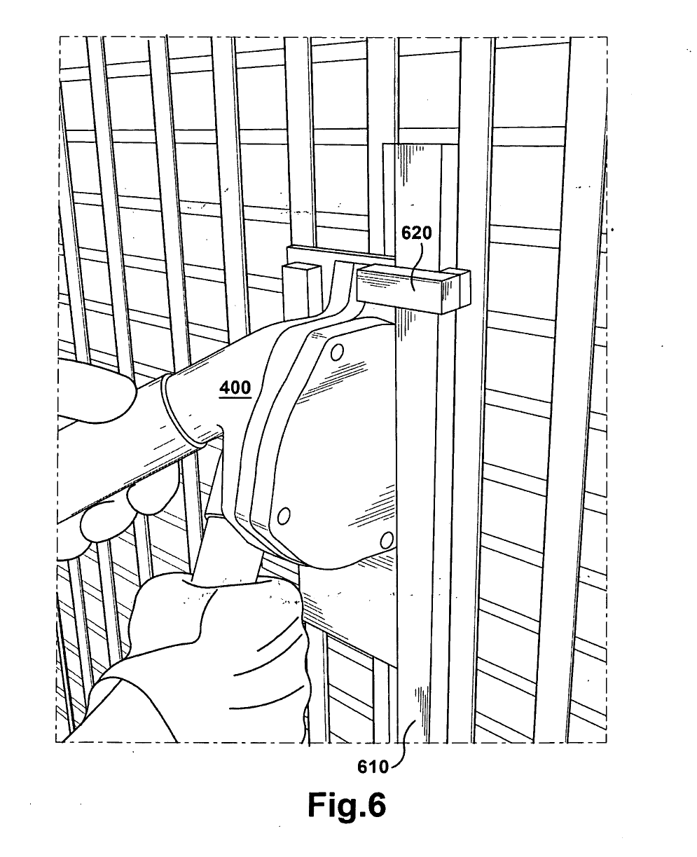

The saw illustrated in FIGS. 4 and 6 are but a few examples of a low profile, reduced weight tool that can be used for removing wedges in a dynamoelectric machine, such as a motor or generator. The individual elements of the saw can be comprised of aluminum, aluminum alloys, steel, steel alloys and other high-strength and/or low weight metals and metal alloys. As described above, some parts of the saw, such as portions of baseplate 450 and spacer blocks can be comprised of polymeric material to protect the dynamoelectric machine during use of the saw.

While the invention has been described in connection with what is presently considered to be one of the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A system for removing a wedge within a slot of an armature or field of a dynamoelectric machine, wherein said armature or field comprises a core, said system comprising:
a saw comprising a blade for cutting said wedge;
at least one guide for guiding said saw along said slot;
wherein, wedge removal is facilitated by using said saw to cut said wedge.

2. The system of claim 1, wherein said blade comprises at least one of:
diamond coated, diamond coated porcelain, diamond impregnated, and steel alloy.

3. The system of claim 1, wherein said saw further comprises:
a motor;
a dust guard; and
a vacuum port.

4. The system of claim 3, wherein said motor is powered by at least one of the following:
compressed air, one or more batteries, AC power, and DC power.

5. The system of claim 3, wherein a vacuum system is connected to said vacuum port to aid in removal of cutting debris.

6. The system of claim 1, further comprising:
at least one guide rail configured to be secured to said armature;
wherein, said at least one guide rail is used to guide said saw along said slot during a cutting operation.

7. The system of claim 6, wherein said at least one guide rail comprises two or more guide rails.

8. The system of claim 6, wherein said at least one guide rail is magnetically secured to said armature or field.

9. The system of claim 6, wherein said at least one guide rail is mechanically secured to said armature or field.

10. The system of claim 6, wherein said at least one guide rail comprises a polymeric material, said polymeric material functioning to protect said core from damage during use of said saw.

11. The system of claim 1, wherein said saw further comprises:
a base configured to provide an adjustable depth of cut.

12. The system of claim 11, wherein said base further comprises:
at least one guide rail connected to said base;
wherein, said at least one guide rail is used to guide said saw along said slot during a cutting operation.

13. A method for removing a wedge from within a slot of an armature or field of a dynamoelectric machine, wherein said armature or field comprises a core, said method comprising:
providing a saw comprising a blade for cutting said wedge;
providing at least one guide for guiding said saw along said slot;
cutting said wedge with said saw; and
removing said wedge from said slot.

14. The method of claim 13, wherein said providing a saw further comprises providing a blade comprising a cutting surface which is at least one of:
diamond coated, diamond coated porcelain, diamond impregnated, and steel alloy.

15. The method of claim 13, wherein said providing a saw further comprises providing:
a motor;
a dust guard; and
a vacuum port.

16. The method of claim 15, wherein said motor is powered by at least one of the following:
compressed air, one or more batteries, AC power, and DC power.

17. The method of claim 15, further comprising:
providing a vacuum source, wherein said vacuum source is connected to said vacuum port to aid in removal of cutting debris.

18. The method of claim 13, further comprising:
providing at least one guide rail configured to be secured to said armature;
wherein, said at least one guide rail is magnetically and/or mechanically secured to said armature, and is used to guide said saw along said slot during a cutting operation.

19. The method of claim 18, wherein said at least one guide rail is comprised of polymeric material, said polymeric material functioning to protect said core from damage during use of said tool.

20. The method of claim 13, wherein said providing a saw further comprises:
providing a base on said saw, said base configured to provide an adjustable depth of cut.
